(19) United States
(12) Patent Application Publication
(10) Pub. No.: US 2006/0230147 A1
(43) Pub. Date: Oct. 12, 2006

(54) Asynchronous frame transmission method for strictly ensuring beginning of super frame in residential ethernet

(75) Inventors: Jae-Hun Cho, Seoul (KR); Jong-Ho Yoon, Goyang-si (KR); Sang-Ho Kim, Hwaseong-si (KR); Yun-Je Oh, Yongin-si (KR); Jun-Ho Koh, Suwon-si (KR); Hee-Kyung Choi, Goyang-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/399,867

(22) Filed: Apr. 7, 2006

(30) Foreign Application Priority Data
Apr. 7, 2005 (KR) 2005-29191

(51) Int. Cl. G06F 15/173

(52) U.S. Cl. 709/225

(57) ABSTRACT

A method for transmitting asynchronous data includes including: comparing a size of asynchronous data with that of an empty transmission area; inserting the asynchronous data into the empty transmission area when the asynchronous data has a size smaller than or equal to that of the empty transmission area; determining if the empty transmission area has a size larger than a predetermined threshold value when the asynchronous data has a size larger than that of the empty transmission area; transmitting the asynchronous data with the empty transmission area left when the empty transmission area has a size smaller than the predetermined threshold value; and segmenting the asynchronous data according to the size of the empty transmission area when the empty transmission area has a size larger than the predetermined threshold value, inserting the segmented asynchronous data into the empty transmission area, and transmitting remaining segmented asynchronous data in a subsequent transmission cycle.

### CLAIM OF PRIORITY

This application claims priority to an application entitled “Asynchronous Frame Transmission Method For Strictly Ensuring beginning of Super Frame In Residential Ethernet,” filed in the Korean Intellectual Property Office on Apr. 7, 2005 and assigned Serial No. 2005-29191, the contents of which are hereby incorporated by reference.

### BACKGROUND OF THE INVENTION

1. Field of the Invention

The present invention relates to Residential Ethernet capable of efficiently and simultaneously providing both the real-time service and non-real-time service by means of Ethernet, and more particularly to a method of strictly ensuring the beginning of a super frame in Residential Ethernet.

2. Description of the Related Art

Ethernet is a local area communication network defined by the Institute of Electrical and Electronics Engineers (IEEE) 802.3 as a standard.

A conventional Ethernet accesses a frame by means of a Carrier Sense Multiple Access/Collision Detect (CSMA/CD) protocol defined in an IEEE 802.3. As such, the Ethernet converts service frames of an upper layer to Ethernet frames for transmission while maintaining an Inter Frame Gap (IFG) interval, and transmits the Ethernet frames in a generation sequence regardless of the type of the upper service frame. Thus, the Ethernet is a technology which may be used universally for transmission of data among a plurality of different terminals or users.

However, the Ethernet has been known to be not suitable for transferring dynamic images or voice data sensitive to transmission time delay. Nowadays, technology capable of transmitting synchronous data such as images/voice by using existing Ethernet has been actively discussed. Such Ethernet for transmission of synchronous data is referred to as a Residential Ethernet.

In Residential Ethernet, frames are transmitted by the cycle. It is common that 125 μs is defined as one cycle. One cycle is divided into an interval for transmission of a synchronous frame and an asynchronous frame. A synchronous frame is an Ethernet frame with a fixed length, and a synchronous frame is an Ethernet frame with a variable length.

In the current Residential Ethernet, the number of synchronous frames within one super frame is restricted to 16 at maximum in order to transmit at least one asynchronous frame during an asynchronous interval. In this case, a maximum of 2,153 bytes may be transmitted during an asynchronous interval.

FIG. 1 is a diagram illustrating the structure of a transmission cycle in a conventional Residential Ethernet.

As illustrated in FIG. 1, the conventional Residential Ethernet being currently discussed provides a transmission cycle for data transmission as one cycle 10 in a unit of 125 μs. Each cycle includes an async frame unit 110 for transmission of asynchronous data and a sync frame unit 100 for transmission of synchronous data.

Specifically, the sync frame unit 100 is a portion with the highest priority in the transmission cycle. According to a proposal being currently discussed, the sync frame unit 100 includes sub-sync frames 101 to 103, each of which has 738 bytes.

The async frame unit 110 includes sub-async frames 111 to 113, each of which has a variable size in a corresponding area.

As frames are transmitted by the cycle in the Residential Ethernet, it is necessary to maintain an exact cycle. However, since a sub-asynchronous frame has a variable length, it is difficult to maintain an exact cycle.

FIG. 2 is a diagram illustrating a scenario in which synchronization is not accomplished by an asynchronous frame in the Residential Ethernet.

As illustrated in FIG. 2, a cycle 21 includes synchronous frames 201 to 203 and asynchronous frames 204 and 205, a cycle 22 includes asynchronous frames 206 and 210 and synchronous frames 207 to 209, and a cycle 23 includes an asynchronous frame 211 and synchronous frames 212 and 213.

In the Residential Ethernet, synchronous data are synchronized at the beginning of the cycles 21 to 23 before transmission. In FIG. 2, the synchronization of the (N+1) cycle 22 is not accomplished by the asynchronous frame 206 of the N cycle 21. Therefore, the (N+1) cycle 22 has delay of Δt₁ 214 at its beginning, and the (N+2) cycle 23 has delay of Δt₂ 215 at its beginning. That is, since an asynchronous frame has a variable length, it is difficult to exactly insert asynchronous frames into each cycle according to the sizes of each cycle. Therefore, it is difficult to achieve a complete synchronization. The delay at the beginning of the super frame frequently occurs as the load of asynchronous traffic increases. Hence, as a transmitted asynchronous frame has a long length, the delay time becomes longer.

Accordingly, in the conventional Residential Ethernet, the beginning of a subsequent super frame may be delayed by an asynchronous frame during transmission in an asynchronous interval. In the worst case, a cycle may also be delayed during a transmission time of a maximum of 1,518 bytes. In this case, the synchronous interval of a subsequent super frame may be reduced.

### SUMMARY OF THE INVENTION

The present invention has been made to solve the above-mentioned problems occurring in the prior art and provides additional advantages, by providing an asynchronous frame transmission method for strictly ensuring the beginning of a super frame in the Residential Ethernet, which controls output or non-output of a transmitted asynchronous frame in order to provide a complete synchronization between transmission cycles in an Residential Ethernet apparatus.

In accordance with one aspect of the present invention, there is provided a method for transmitting asynchronous data in Residential Ethernet. The size of asynchronous data to be transmitted is compared with a size of an empty transmission area in an asynchronous frame unit. The asynchronous data to be transmitted is inserted into the empty transmission area in the asynchronous frame unit when the asynchronous data to be transmitted has a size smaller than or equal to the size of the empty transmission area, and it is determined if the empty transmission area has a size larger than a predetermined threshold value when the asynchronous data to be transmitted has a size larger than the size of the empty transmission area. The asynchronous data is transmitted with the empty transmission area left when the empty transmission area has a size smaller than the predetermined threshold value. The asynchronous data is segmented according to the size of the empty transmission area when the empty transmission area has a size larger than the predetermined threshold value, and the segmented asynchronous data is inserted into the empty transmission area, and then remaining segmented asynchronous data is transmitted in a subsequent transmission cycle.

### BRIEF DESCRIPTION OF THE DRAWINGS

The above features and advantages of the present invention will be more apparent from the following detailed description taken in conjunction with the accompanying drawings, in which:

FIG. 1 is a diagram illustrating the structure of a transmission cycle in a conventional Residential Ethernet;

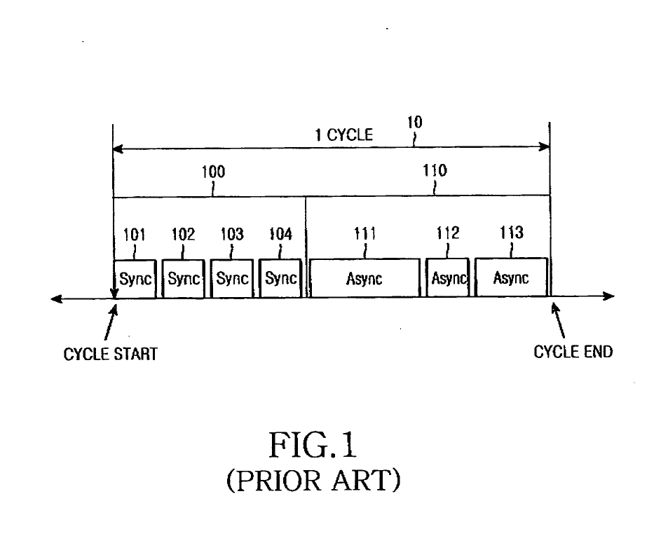

FIG. 2 is a diagram illustrating a case in which synchronization is not accomplished by an asynchronous frame in the Residential Ethernet;

FIG. 3 is a diagram illustrating a transmission cycle according to a hold method for complete synchronization in the Residential Ethernet;

FIG. 4 is a diagram illustrating a transmission cycle according to a segmentation method for complete synchronization in the Residential Ethernet;

FIG. 5 is a diagram illustrating the structure of an asynchronous frame in the Residential Ethernet according to one embodiment of the present invention; and

FIG. 6 is a flow diagram illustrating an asynchronous frame transmission method for strictly ensuring the beginning of a super frame in the Residential Ethernet according to the present invention.

### DETAILED DESCRIPTION

An embodiment of the present invention will be described in detail herein below with reference to the accompanying drawings. It should be noted that the similar components are designated by similar reference numerals although they are illustrated in different drawings. For the purposes of clarity and simplicity, a detailed description of known functions and configurations incorporated herein will be omitted as it may obscure the subject matter of the present invention.

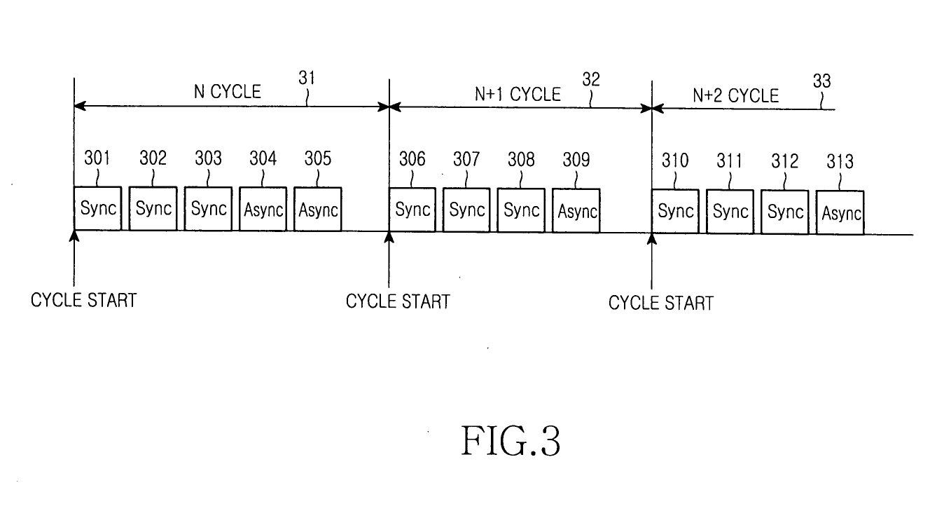

FIG. 3 is a diagram illustrating a transmission cycle according to the inventive hold method for providing a complete synchronization in the Residential Ethernet.

Referring to FIG. 3, a cycle 31 includes synchronous frames 301 to 303 and asynchronous frames 304 and 305 for transmission, a cycle 32 includes synchronous frames 306 to 308 and an asynchronous frame 309 for transmission, and a cycle 33 includes synchronous frames 310 to 312 and an asynchronous frame 313 for transmission.

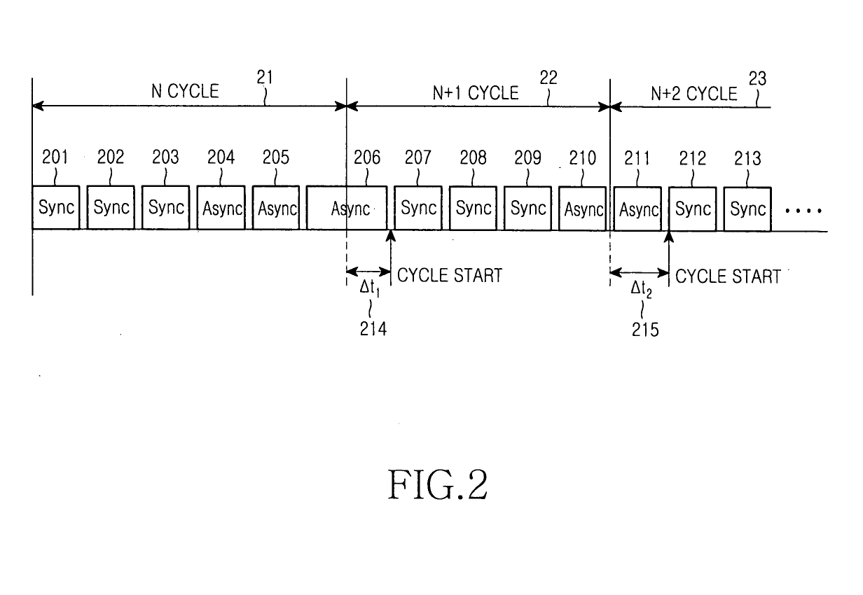

Differently from the transmission cycle in FIG. 2, FIG. 3 shows that synchronization of the beginning of each cycle is completely accomplished. This is achieved through a transmission control of an asynchronous frame. In the case of the N cycle 31, after the asynchronous frame 305 is transmitted, the N cycle 31 has an extra transmission area. This transmission area is smaller than the size of the first asynchronous frame 309 of the (N+1) cycle 32. Accordingly, the corresponding area is held and the asynchronous frame 309 is controlled to be transmitted in a subsequent cycle, so that a complete synchronization can be maintained.

According to the teachings of the present invention as described above, the size of an asynchronous frame A to be transmitted is compared with the size of an asynchronous frame transmission area B remaining in a corresponding transmission cycle. If the asynchronous frame A to be transmitted has a size larger than that of the asynchronous frame transmission area B, an asynchronous frame is transmitted while the corresponding area B is left empty in the corresponding cycle and the remaining asynchronous frame A is transmitted in a subsequent cycle.

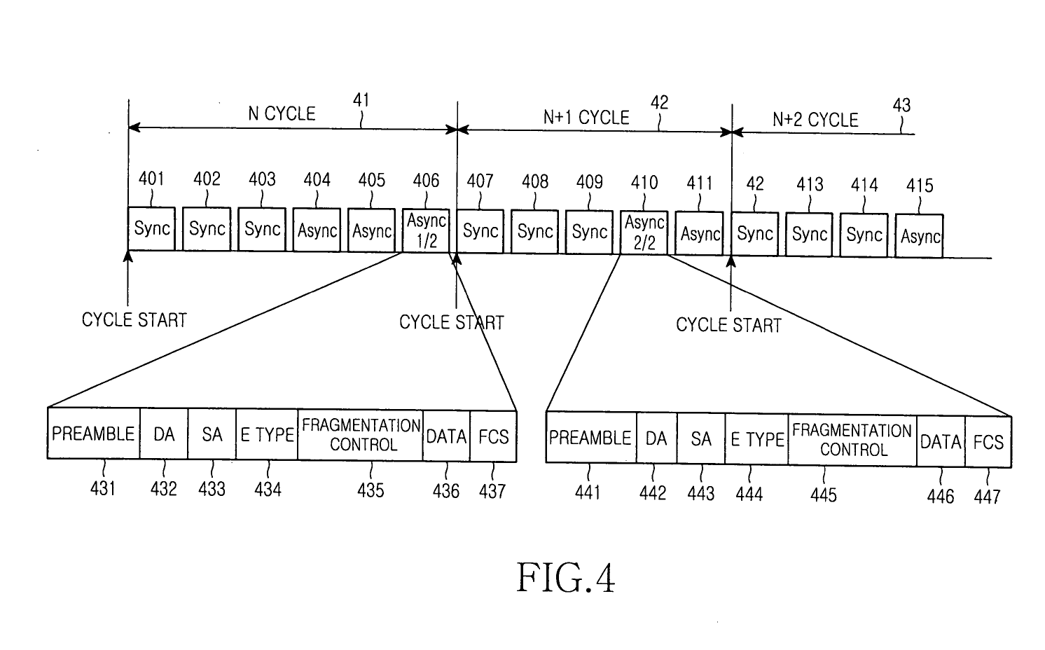

FIG. 4 is a diagram illustrating a transmission cycle according to a segmentation method to complete a synchronization in the Residential Ethernet.

Referring to FIG. 4, a cycle 41 includes synchronous frames 401 to 403 and asynchronous frames 404 to 406 for transmission, a cycle 42 includes synchronous frames 407 to 409 and asynchronous frames 410 and 411 for transmission, and a cycle 43 includes synchronous frames 412 to 414 and an asynchronous frame 415 for transmission.

Differently from the transmission cycle in FIG. 2, FIG. 4 shows that synchronization of the beginning of each cycle is completely accomplished through a transmission control of an asynchronous frame. In the case of the N cycle 41, after the asynchronous frame 405 is transmitted, the N cycle 41 has an extra transmission area. This transmission area is smaller than the size of the asynchronous frames 406 and 410 to be currently transmitted. Accordingly, the asynchronous frames to be currently transmitted are segmented and transmitted, so that a complete synchronization can be maintained.

More specifically, when it is assumed that an asynchronous frame area empty for transmission of asynchronous data has a length of L1 in the N cycle 41 and asynchronous data to be input for transmission have a length of L2, if the L1 is the same as the L2 or if the L1 is longer than the L2, the asynchronous data to be input for transmission are input to the asynchronous frame area and transmitted.

However, if the L2 is longer than the L1, the asynchronous data with the length of L2 are segmented by the L1, which is the length of the empty asynchronous frame area, so as to generate the asynchronous frame 1/2 406, and the asynchronous frame 406 is transmitted through the N cycle 41. The asynchronous frame 1/2 406 includes a preamble field 431, a Destination Address (DA) field 432, a Source Address (SA) field 433, an Ethernet (E) type field 434, a fragmentation control field 435, and a Frame Check Sequence (FSC) field 437.

Thereafter, a part with a length of “L2-L1” is inserted into the first asynchronous frame 2/2 410 in the subsequent (N+1) cycle 42 and transmitted. The asynchronous frame 2/2 410 includes a preamble field 441, a DA field 442, a SA field 443, an E type field 444, a fragmentation control field 445, and a FSC field 447, similarly to the asynchronous frame 1/2 406, as well as the part with the length of “L2-L1”.

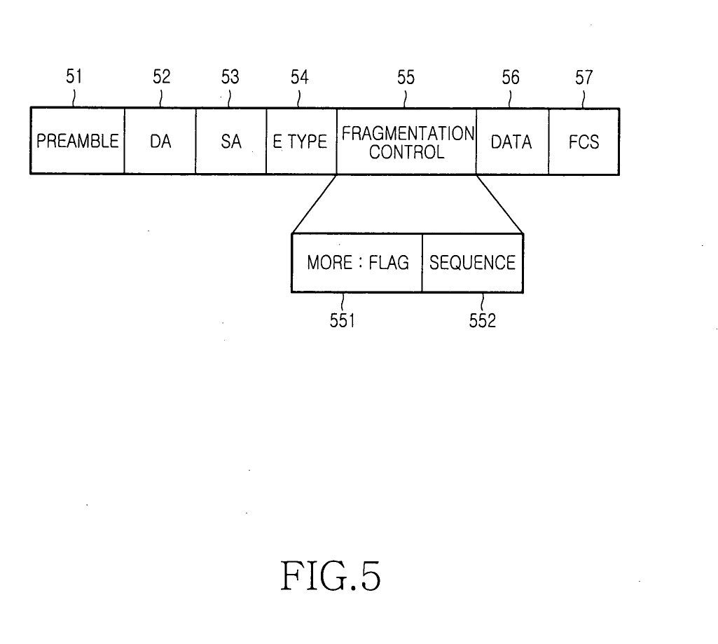

FIG. 5 is a diagram illustrating the structure of an asynchronous frame in the Residential Ethernet according to one embodiment of the present invention.

As illustrated in FIG. 5, the asynchronous frame in the Residential Ethernet according to the present invention includes a preamble field 51 of 8 bytes, a DA field 52 of 6 bytes, a SA field 53 of 6 bytes, an E type field 54 of 2 bytes, a fragmentation control field 55 of 2 bytes, a data field 56, and a FSC field 57 of 4 bytes. The preamble field 51 indicates the beginning and ending of the frame, and the DA field 52 indicates a destination Media Access Control (MAC) address to which the frame must be transmitted. The SA field 53 indicates an MAC address of a station transmitting the frame, and the E type field 54 indicates a protocol type of the frame. The fragmentation control field 55 indicates if the frame is segmented and transmitted, and the data field includes data to be transmitted. The FSC field 57 is provided for error detection, which is disposed at the end of each frame when frame-by-frame information is transmitted during data communication.

The fragmentation control field 55 includes a More flag 551 of one bit and a sequence 552 of 15 bits. The More flag 551 indicates that the frame is segmented and transmitted, and the sequence 552 is transmitted to a reception-side in order to be used for reassembling the segmented frame. That is, frames with the same sequence number are collected and may be reassembled in the MAC of the reception-side. In the structure of the asynchronous frame as described above, the new E type field 54 about the segmented frame is set to “0x8889”. Further, all frames, excluding the last area of the segmented frame, set the More flag to “1”, and only the last frame sets the More flag to “0”. These setting values are given by way of illustration only for description of the present invention, so they should not limit the scope of the present invention and may be altered according to operation of a system.

In addition, when a frame is segmented, an Ethernet header attached to the frame 406 before segmentation, and segmentation information of two bytes are used for the last area 410 of the segmented frame.

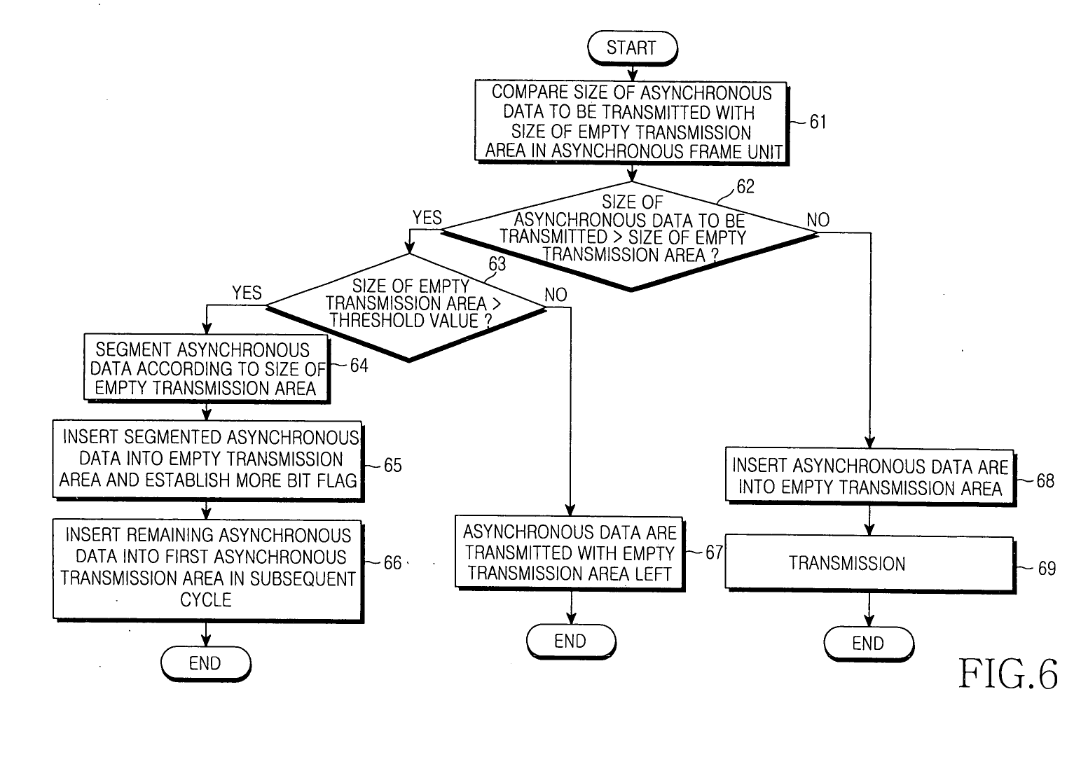

FIG. 6 is a flow diagram illustrating an asynchronous frame transmission method for strictly ensuring the beginning of a super frame in the Residential Ethernet according to the present invention.

In order to strictly ensure the synchronization of a super frame, the present invention combines the method of holding an asynchronous frame with the method of segmenting the asynchronous frame, and establishes a threshold value for selectively using the combined method. Alternatively, the present invention provides a selection for one of these two methods.

Referring to FIG. 6, the size L2 of asynchronous data to be transmitted is compared with the size L1 of an empty transmission area in an asynchronous frame unit (61).

As a result of the comparison, when the size L2 of the asynchronous data is smaller than or equal to the size L1 of the empty transmission area (62), the asynchronous data are inserted (68) into the empty transmission area of the corresponding asynchronous frame unit and then transmitted (69).

However, when the size L2 of the asynchronous data is larger than the size L1 of the empty transmission area (62), it is determined whether the size L1 of the empty transmission area is larger than a preset threshold value is determined (63).

The preset threshold value is a value of an area, above which the effect of frame fragmentation can be obtained. That is, if a remaining frame has a size insufficient for forming the header of an asynchronous frame, it is not necessary to segment the asynchronous data. Accordingly, in the present invention, the preset threshold value is set to 48 bytes.

The 48 bytes correspond to a sum of 8 bytes of the preamble field 51, 6 bytes of the DA field 52, 6 bytes of the SA field 53, 2 bytes of the E type field 54, 2 bytes of the fragmentation control field 55 added for fragmentation control, and 24 bytes of an Inter Frame Gap (IFG) for distinguishing frames in Ethernet.

As a result of the determination (63), when the size L1 of the transmission area is smaller than the preset threshold value, the asynchronous data are transmitted with the empty transmission area left by means of the hold method (67).

However, when the size L1 of the transmission area is larger than the preset threshold value, the segmentation method is used.

The segmentation method has the following steps.

First, the asynchronous data are segmented according to the size L1 of the empty transmission area in the asynchronous frame unit (64). Then, the segmented asynchronous data are inserted into the empty transmission area in the corresponding asynchronous frame unit and a More flag is established (65).

The remaining asynchronous data with the size of (L2-L1), excluding the segmented asynchronous data of the asynchronous data to be transmitted, are inserted as the first asynchronous frame of an asynchronous frame unit in a subsequent transmission cycle and then transmitted (66).

According to the present invention as described above, in constructing the Residential Ethernet, a predetermined threshold value is established in order to reduce the waste of bandwidth in a super frame with a fixed length, and a hold method and a segmentation method are selectively used, so that it is possible to prevent delays in the beginning of the super frame from occurring during the transmission of an asynchronous frame.

Further, according to the present invention, it is possible to reduce the load of a MAC which occurs due to an unnecessary segmentation operation, as compared with a case of using only the existing segmentation method.

Furthermore, according to the present invention, it is possible to improve the degree of bandwidth usage, as compared with a case of using only the prior art segmentation method.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A method for transmitting asynchronous data in Residential Ethernet, the method comprising:
comparing a size of asynchronous data to be transmitted with an empty transmission area in an asynchronous frame unit;
inserting the asynchronous data to be transmitted into the empty transmission area in the asynchronous frame unit when size of the asynchronous data to be transmitted is smaller than or equal to size of the empty transmission area;
determining if the empty transmission area has a size larger than a predetermined threshold value when the asynchronous data to be transmitted has a size larger than the size of the empty transmission area;
transmitting the asynchronous data with the empty transmission area left when the empty transmission area has a size smaller than the predetermined threshold value; and
segmenting the asynchronous data according to the size of the empty transmission area when the empty transmission area has a size larger than the predetermined threshold value, inserting the segmented asynchronous data into the empty transmission area, and transmitting remaining segmented asynchronous data in a subsequent transmission cycle.

2. The method as claimed in claim 1, wherein an asynchronous frame in the asynchronous frame unit includes a preamble field for indicating beginning and end of the asynchronous frame, a Destination Address (DA) field for indicating a destination Media Access Control (MAC) address to which the asynchronous frame must be transmitted, a Source Address (SA) field for indicating a MAC address of a station transmitting the asynchronous frame, an Ethernet type field for indicating a protocol type of the asynchronous frame, a fragmentation control field for indicating information regarding whether the asynchronous frame has been segmented, a data field for accommodating data to be transmitted through the asynchronous frame, and a Frame Check Sequence (FCS) field for error detection, the FSC field being disposed at an end of each frame when frame-by-frame information is transmitted in data communication.

3. The method as claimed in claim 2, wherein the fragmentation control field includes a More flag for indicating that the asynchronous frame is segmented and transmitted, and a sequence transmitted to a reception-side in order to be used for reassembling the segmented frames.

4. The method as claimed in claim 3, wherein the predetermined threshold value is larger than a value obtained by summing up both data areas for the preamble field, the DA field, the SA field, the Ethernet type field, and the fragmentation control field of the asynchronous frame, and an Inter Frame Gap (IFS) area for preventing collision between frames.

5. The method as claimed in claim 3, wherein a frame based on remaining asynchronous data segmented in the segmenting step uses header information and fragmentation control information of the segmented asynchronous frame.
